(19) United States
(12) Patent Application Publication
(10) Pub. No.: US 2024/0344591 A1
(43) Pub. Date: Oct. 17, 2024

(54) Sequential amplification of moment of inertia using axle-to-rim-to-rim-to-axle -to-axle flywheel interconnections

(71) Applicant: Hong Cho Yew, Escondido, CA (US)

(72) Inventor: Hong Cho Yew, Escondido, CA (US)

(21) Appl. No.: 18/629,502

(22) Filed: Apr. 8, 2024

Related U.S. Application Data
(60) Provisional application No. 63/495,457, filed on Apr. 11, 2023.

(51) Int. Cl. F16F 15/31

(52) U.S. Cl. CPC F16F 15/31

(57) ABSTRACT

Balanced and round mass of an object, herein called as a flywheel, has moment of inertia at the center of mass that is I_{com}=½ MR\hat{ }2, where M=mass R=radius. At the rim of mass the moment of inertia is, Iᵣᵢₘ=I_{com}+MR\hat{ }2= 3/2MR\hat{ }2. This shows three times more in moment of inertia at the end of R. Transferring this increased moment of inertia to the next flywheels for further increase and applying wheel-and-axle moment arm is the core of this invention.

### FIELD OF INVENTION

Since moment of inertia has just mass (kg) of an area of radius R\hat{ }2 (meter squared), once it is in motion, it stays in motion. Initially, a massive flywheel at a standstill would require an equally massive force to rotate the mass requiring high inrush current for a motor to rotate. This is where a lever arm (moment arm) contributes a vital role of force amplification that substantially reduces input driving force. The first flywheel is driven by an external driving force at the center of mass M. At the rim of this first flywheel, a chain or a belt is connected to second flywheel at the rim for rim-to-rim connection. This maximizes transfer of moment of inertia between the two flywheels.

The second flywheel provides a wheel-and-axle driven by chain or belt offering ideal mechanical advantage (IMA)=R/r, where R is radius of this second flywheel, and r is radius of axle (drive shaft). This second flywheel, driven by IMA=R/r, drives the third flywheel at the center of mass for center-of-mass-to-center-of-mass or axle-to-axle (drive shaft-to-drive shaft) connection by transferring this amplified moment of inertia to the third flywheel. Short displacement at the axle (drive shaft) allows maximum transfer of amplified force to the third flywheel.

Third flywheel mass is increased to near, but not over, the magnitude of lever amplification ratio of R/r multiplied by the combined moment of inertia of two flywheels in series connected from rim-to-rim. This added mass does not increase load to the input driver because of the lever arm R/r provides the amplified force at the expense of moving short distance at the axle (drive shaft). Now, system has more mass added for more stored energy with minimally affecting the original input load. This is key to this invention. When two identical flywheels are in series and connected by a chain or a belt at rim, combined moment of inertia increases based on parallel axis theorem of point mass by M(R+R)\hat{ }2, where R+R represents two flywheels in series.

By connecting a chain or a belt from rim of this third flywheel to an axle of a load can see the benefit of increased rotational kinetic energy coming from the mass increased. This is the first stage of sequential amplification of moment of inertia.

Iₜₒₜₐₗ=½ M1*(R1)\hat{ }2+(M1*(R1)\hat{ }2)*2+½ M2*(R2)\hat{ }2)+(M2*(R2)\hat{ }2)*2= 5/2M1*(R1)\hat{ }2+ 5/2M2*(R2)\hat{ }2. Each of flywheel point mass MR\hat{ }2 is multiplied by 2 because there are two point mass present when we have two strand turning mechanism.

When mass and radius of first and second flywheels are same, M1=M2 and R1=R2, then, combined moment of inertia of these two flywheels is,

Iₜₒₜₐₗ=½MR\hat{ }2+M(R+R)\hat{ }2+½MR\hat{ }2=5MR\hat{ }2.

This combined moment of inertia is further amplified by the R/r ratio. If R/r=10, M1 and M2=1, and R1 and R2=1, then the mass can be increased to 5MR\hat{ }2*(R/r)=50.

This means the third flywheel mass can be increased to 50 times of the first or second flywheel. If R=0.5, M=1, and R/r=10, then it becomes 5MR\hat{ }2*(R/r)=5*1*(0.5\hat{ }2)*10=12.5. As the flywheel gets smaller than 1 meter in radius, the effectiveness of R/r is reduced.

Third flywheel is connected to the fourth flywheel via a chain or a belt at the rim for rim-to-rim connection. This is the same configuration to the first two flywheels, and the output of the fourth flywheel is located at the center of mass that is the axis of rotation with IMA=R/r. Continuation of this serially configured connections is made for further increase in moment of inertia for greater rotational kinetic energy output.

Mass and radius of fourth flywheel is determined based on load requirements using the math equations shown above.

Next flywheel connected to fourth flywheel will have the same function as the third flywheel but with far more mass increase than the third flywheel. Output from this next flywheel will be second stage output of sequentially amplified moment of inertia applicable to driving a much heavier load than the first stage output.

### SUMMARY

When mass of flywheel is sequentially increased, this mass increase becomes the stored energy that is rotated at desired RPM for rotational kinetic energy that drives generators or other load while the input driving force is relatively unchanged except during the short period of inrush current at the startup.

Energy of a rotating round object is E=½*|*W\hat{ }2 where I is moment of inertia and W is angular velocity. So, moment of inertia and angular velocity are two components for energy. Therefore, increasing moment of inertia by increasing mass of subsequent flywheels is proportional to increasing rotational kinetic energy along with angular velocity.

### DESCRIPTION OF FIGURES

FIG. 1 illustrates three flywheels connected in series. Flywheel No. 1 and No. 2 are connected using belt or chain at rims. Flywheel No. 2 and No. 3 are connected from center of mass to center of mass.

FIG. 2 illustrates how IMA=R/r is obtained. Throughout the system all flywheels have the same radius and rotate at the same rate.

FIG. 3 illustrates how moment of inertia is increased and multiplied in four flywheel configuration.

FIG. 4 shows major components in this system listed and identified by numbers.

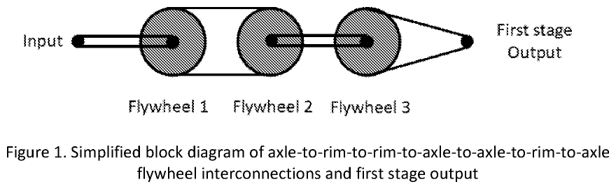

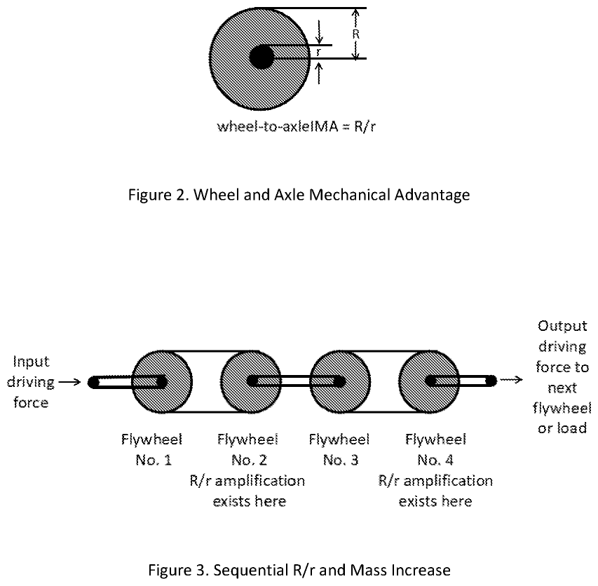

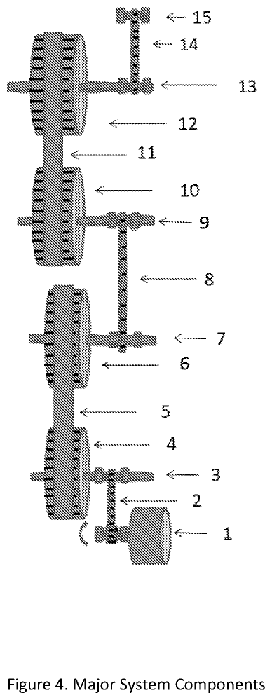

1. Input motor that drives flywheel 1 at the center of mass.
2. Driving belt or chain that connects input drive motor to the first flywheel at the center of mass.
3. Drive shaft of flywheel 1.
4. Flywheel 1.
5. Driving chain or belt that connects flywheel 1 and flywheel 2 at rim-to-rim.
6. Flywheel 2.
7. Drive shaft of flywheel 2.
8. Driving chain or belt that connects flywheel 1 and flywheel 2 at axle-to-axle.
9. Drive shaft of flywheel 3.
10. Flywheel 3.
11. Driving chain or belt that connects flywheel 3 and flywheel 4 at rim-to-rim.
12. Flywheel 4.
13. Drive shaft of flywheel 4.
14. Driving chain or belt that connects flywheel 4 output to load or to another flywheel at axle-to-axle.
15. Output shaft. This is similar to second flywheel where R/r amplification exists for adding more mass or load.

I claim:

1-3. (canceled)

4. Sequential amplification of moment of inertia of flywheels comprising:
An input driving force;
A first flywheel rotary shaft which is rotated by said input driving force connected by a chain or a belt;
A first flywheel rotated by coupling with said first flywheel rotary shaft;
A second flywheel with wheel-and-axle amplification connected by a chain or a belt to said first flywheel from rim-to-rim;
A second flywheel rotary shaft which is coupled to and rotated by said second flywheel;
A third flywheel rotary shaft which is rotated by said second flywheel rotary shaft connected by a chain or a belt;
A third flywheel that has mass increased up to but not exceeding wheel-and-axle amplification ratio of said second flywheel multiplied by combined moment of inertia of said first and said second flywheel;
An output chain or belt connected to rim of said third flywheel; and
An output shaft that is coupled to and driven by said output chain or belt of said third flywheel.

5. Sequential amplification of moment of inertia comprising:
A fourth flywheel with wheel-and-axle amplification for further amplification of moment of inertia by connecting from rim-to-rim between said third flywheel and said fourth flywheel by a chain or a belt.

6. Sequential amplification of moment of inertia as in claim 5 further comprising:
A fourth flywheel rotary shaft which is coupled to and rotated by said fourth flywheel that connects to a next flywheel or a load.
